(19) United States
(12) Patent Application Publication
(10) Pub. No.: US 2022/0163626 A1
(43) Pub. Date: May 26, 2022

(54) REALTIME SELECTION OF ELECTRONIC COUNTERMEASURES AGAINST UNKNOWN, AMBIGUOUS OR UNRESPONSIVE RADAR THREATS

(71) Applicant: BAE SYSTEMS Information and Electronic Systems Integration Inc., Nashua, NH (US)

(72) Inventors: Scott A. Kuzdeba, Hollis, NH (US); Brandon P. Hombs, Merrimack, NH (US); Peter J. Kajenski, Amherst, NH (US); Daniel Massar, Bedford, NH (US)

(21) Appl. No.: 16/953,562

(22) Filed: Nov. 20, 2020

(51) Int. Cl. G01S 7/36; G01S 7/02

(52) U.S. Cl. CPC G01S 7/36; G01S 7/021

(57) ABSTRACT

One or more defined countermeasures are selected from a countermeasure library, populated with parameters, and applied against an unknown, ambiguous, or unresponsive imminent radar threat based on an analysis of a hostile RF waveform emitted by the radar threat. The analysis can include comparing static and/or dynamic features of the hostile RF waveform with features of known hostile RF waveforms. A parameter set associated with the selected defined countermeasure in the countermeasure library can be selected. Waveform features can be categorized and sub-categorized for comparison with the known hostile waveforms. A plurality of features can be detected and compared. The analysis can include correlating behavior patterns of a plurality of hostile RF waveforms emitted by the radar threat. A cognitive intelligence trained using a threat database and library of corresponding countermeasures can analyze the hostile RF waveform, select the defined countermeasure, and/or select or generate the parameters.

### RELATED APPLICATIONS

This application is related to U.S. applications Ser. No. 16/953,568, Ser. No. 16/953,579, and Ser. No. 16/953,659, all of which were filed on Nov. 20, 2020. All of these applications are herein incorporated by reference in their entirety for all purposes.

### STATEMENT OF GOVERNMENT INTEREST

Portions of the present invention may have been made pursuant to United States Defense Advanced Research Projects Agency (DARPA) Contract Number HR0011-13-C-0029, and there may be certain rights to the United States Government.

### FIELD

The disclosure relates to countermeasures against wireless electronic threats, and more particularly to electronic countermeasures against hostile radars.

### BACKGROUND

Most of the electronic warfare (EW) countermeasure systems that are currently deployed against radar threats implement an electronic countermeasure (ECM) strategy whereby a detected waveform that is transmitted by a hostile radar is compared to a threat database, i.e. a database of known hostile RF waveforms, so as to match the detected waveform with a known hostile RF waveform and thereby identify the radar threat as being a of a known type and having known behavior and waveform characteristics. The identity of the detected radar is then used to select an appropriate countermeasure strategy and associated parameter settings (if any) from a library of predetermined and pre-verified countermeasures. The selected countermeasure is then applied as specified to mitigate the threat.

This existing approach to electronic warfare relies upon an assumption that hostile radars will almost always be of a known type, will implement previously observed waveforms and other behaviors, and will not be able to respond or adapt to the applied countermeasure. However, the validity of these assumptions is increasingly being called into question.

Wireless electronic threats such as hostile radar systems are rapidly evolving from primarily analog systems having RF waveforms and other characteristics that are fixed, or at least limited and predictable in scope, to mainly digital systems having waveforms and other characteristics that are software controlled and programmable, such that the waveforms and other threat characteristics can be easily and quickly changed. As a result of this evolution to primarily digital systems, radar threats are becoming increasingly “agile,” in that they are able to flexibly alter their waveforms, which can render the hostile radar sources more difficult to identify. Therefore, it can no longer be assumed that a majority of the radar threats that are encountered in battle will be of known types emitting known RF waveforms.

As a result, friendly assets that encounter a radar threat that cannot be identified could be forced either to withdraw or to proceed without applying a countermeasure. As used herein the term “asset” refers to any person or object that is of value and may require protection from hostile threats. For example, an asset can be a fixed or mobile air, land, maritime or space-based vehicle. Some examples include tanks, personnel carriers, helicopters, UAV, planes and ships.

Furthermore, future hostile radar systems will likely be able to sense their environment and adapt their waveforms to maximize performance and attempt to mitigate any detected countermeasures. As a result, the effectiveness of an electronic countermeasure against a radar threat can no longer be assumed, even if the radar threat can be identified as a known threat and the electronic countermeasure has been previously validated for effectiveness against the known radar threat. This could result in the adoption of a misguided battle strategy under a false assumption that a radar threat has been neutralized, when in fact an applied countermeasure is being mitigated and is not able to sufficiently disrupt the radar threat.

What is needed, therefore, is a system and method for selecting and implementing a countermeasure that is effective against a radar threat when the radar threat is either an unidentified or ambiguous radar threat, or is identified as a known radar threat but is not being sufficiently disrupted by a previously validated countermeasure.

### SUMMARY

The present disclosure is an apparatus and method for selecting and implementing a countermeasure that is effective against a radar threat when the radar threat is either an unidentified or ambiguous radar threat, or is identified as a known radar threat but is not being sufficiently disrupted by a previously validated countermeasure.

### DEFINITIONS OF TERMS

For ease of expression, and unless otherwise required by context, the following terms and their obvious variants are used herein with the following meanings, unless otherwise required by context:

The terms “hostile radar” and “radar threat” are used herein to refer to any hostile threat that emits electromagnetic radiation and is subject to countermeasures. The term “imminent” radar threat is used herein to refer to a radar threat that poses a current danger to an asset, and the term “imminent” RF waveform refers to an RF waveform that is being emitted by an imminent radar threat.

The terms “countermeasure” and “electronic countermeasure” or “ECM” refer to any action that can be applied against a hostile radar in an attempt to “disrupt” the hostile radar, i.e. to mitigate the threat posed by the hostile radar. The “effectiveness” of an applied countermeasure refers to a degree to which the applied countermeasure is able to “mitigate” the hostile threat, i.e., reduce the threat posed by the hostile radar to an asset. An “effective” countermeasure refers to a countermeasure that meets defined effectiveness criteria by reducing the threat posed by a hostile radar to an acceptable degree. An example of a defined effectiveness criterion could be a requirement that a projectile or missile that is guided by the radar threat is caused to miss its intended target by a defined distance. Another example might be a requirement that a radar threat that changes its behavior when a target is detected, for example by continuing to direct its RF emissions toward the target, is caused by an applied countermeasure to return to a behavior that is typical when a target has not been detected, such as continuously varying the direction in which it emits RF.

The terms “radio frequency” and “RF” are used herein to refer to electromagnetic radiation emitted at any frequency.

The terms “waveform” and “RF waveform” are used herein to refer to all of the fixed and time-varying features that characterize the RF that is emitted by a hostile radar. Examples of features that can characterize an RF waveform include, but are not limited to, static features such as geographic distribution patterns of the emitted RF, number and selection of RF frequencies, and number and relative selections of RF phases, as well as time dependent features such as RF phase variation patterns, RF frequency variation patterns, such as frequency “hopping” patterns, and RF amplitude variation patterns, such as duty factors, timing, and shaping of pulses and/or other amplitude modulations. All time dependent patterns of changes in an RF waveform, i.e. “behaviors” of the RF waveform, are also considered to be features. As such, the term “features” is not limited herein to static features, but is used to refer to both static characteristics and dynamic behaviors of an RF waveform. An RF waveform is always associated with a specific radar. However, it is sometimes convenient to characterize a specific radar as emitting more than one RF waveform, either simultaneously or at different times.

The terms “known” RF waveform and “known” radar threat are used herein to refer to an RF waveform and associated radar threat that have been previously encountered and characterized, and that are included in an available “threat database.” It is generally assumed that for each known radar threat included in a threat database a there is at least one known countermeasure recorded in a countermeasure library that has been previously verified to be effective against the known radar threat.

If most or all of the features of an imminent RF waveform are similar or identical to corresponding features of a known RF waveform recorded in a threat database, then the RF waveforms are said to “match,” and the known radar threat is said to “match” the imminent radar threat. An imminent RF waveform that matches a known RF waveform included in an available threat database is also referred to as a “known” RF waveform,” and an immanent radar threat that is emitting a known RF waveform and is disrupted by a corresponding pre-verified countermeasure is referred to herein as a “known” threat or “known” radar threat.

The term “novel” RF waveform refers to a detected RF waveform having features that do not substantially match a set of features of any known RF waveform. Similarly, the terms “novel” radar threat, “novel” radar and “novel” threat all refer to a radar threat that is emitting a novel RF waveform.

The term “ambiguous” RF waveform refers to an imminent RF waveform that at least partially matches a plurality of known RF waveforms, thereby resulting in an ambiguity as to whether the imminent RF waveform is a match to any of the known RF waveforms, or if the imminent RF waveform is a novel RF waveform that coincidentally has features that overlap with features of the plurality of known RF waveforms. The terms ambiguous threat, ambiguous radar threat, and ambiguous hostile radar all refer to a radar threat that is emitting at least one ambiguous RF waveform.

The terms “unresponsive” radar and “unresponsive” radar threat are used to refer to a radar threat that is emitting a known RF waveform, but against which a countermeasure that was previously verified as being effective against the radar threat is no longer sufficiently effective. The term “unresponsive” RF waveform is used to refer to an RF waveform emitted by an unresponsive radar threat.

The terms “defined” countermeasure and “defined” ECM refer to an electronic countermeasure that is included in a library of available countermeasures and is associated with at least one parameter that must be set or “populated” before the countermeasure is applied. Said parameters are referred to as countermeasure or ECM parameters and/or as the parameters or parameter set of the countermeasure or ECM. A countermeasure in combination with an associated parameter set in which all of the parameters have been specified is referred to herein as a “populated” countermeasure. A given defined countermeasure, when populated by different sets of ECM parameters, may be effective against different known and/or unknown threats.

The term “known” countermeasure refers to a defined countermeasure that has been populated with a corresponding set of ECM parameters (if any), where the defined countermeasure and associated parameter set are both included in an available countermeasure library, and wherein the known countermeasure has been previously verified to be effective against at least one known threat.

According to the present disclosure, detected features of at least one RF waveform that is emitted by an imminent radar threat that is novel, ambiguous, or unresponsive are used as a basis for selecting a defined countermeasure from a countermeasure library. If a plurality of RF waveforms are detected that are emitted by the same imminent radar threat, then embodiments select a defined countermeasure according to detected features of more than one of the detected RF waveforms and/or according to correlations between the behavior patterns of more than one of the detected waveforms. In some embodiments, a plurality of defined countermeasures may be selected and implemented simultaneously and/or alternately in response to detection of one or more known and/or novel waveforms being emitted by a hostile radar.

Embodiments characterize each novel detected waveform and each known threat waveform according to a plurality of feature categories. For example, if the feature categories include amplitude modulation type, frequency modulation type, and geographic dispersion pattern, then a first waveform might be characterized according to these categories as having a fixed amplitude, a fixed frequency, and a swept, 360 degree geographic dispersion pattern, while a second waveform might be characterized as having a pulsed amplitude modulation, a hopped frequency modulation, and a geographic dispersion pattern that is a focused beam having a fixed direction. Sub-categories can also be included as part of the feature characterizations, such as a pulse repetition rate and duty cycle applicable to pulsed amplitude modulation, and a number of frequencies included in a frequency hopping modulation.

This approach of characterizing waveforms according to categories and sub-categories of features can enable a rapid identification among the known threat waveforms of a “closest match” that “matches” the detected novel waveform in the largest number of feature categories and sub-categories. In some embodiments, the defined countermeasure that is most effective against the closest match threat waveform is then selected and applied to the detected novel waveform.

Embodiments further attempt to determine relationships or “links” between waveform features and defined countermeasures, and these links are used to further optimize the selection of a defined countermeasure to be applied against a detected novel threat. For example, if a “first” defined countermeasure, when populated with an appropriate set of parameters, is effective against a first plurality of known threat waveforms, all of which include frequency hopping, while a second defined countermeasure, when populated with an appropriate set of parameters, is effective against a second plurality of known threat waveforms, none of which include frequency hopping, then in embodiments the “first” defined countermeasure will be deemed to be linked to frequency hopping, while the second defined countermeasure will not be linked to frequency hopping. Accordingly, if a detected novel waveform that includes frequency hopping is closely matched both to a known threat waveform from the first plurality and also to a known threat waveform of the second plurality, then the first defined countermeasure will likely be selected due to the link between the first countermeasure and frequency hopping.

In certain embodiments, rather than simply counting the number of feature category and sub-category matches between a detected novel waveform and a threat database of known waveforms, the selection of a known or defined countermeasure is data driven in parameter space, wherein a data-driven learned mapping is constructed between observed features of the novel, ambiguous, or unresponsive RF waveform and features of known RF waveforms associated with known threats against which defined or known countermeasures are known to be effective. For example, artificial intelligence can be used to select an optimal defined or known countermeasure to be used against a hostile radar that emits a novel, ambiguous, or unresponsive RF waveform. In some of these embodiments, a plurality of known threat waveforms and their associated defined and/or known countermeasures are provided as training data to the artificial intelligence, after which the trained artificial intelligence is able to select an optimal defined or known countermeasure from a countermeasure library in response to the detection of a novel, ambiguous, or unresponsive RF waveform. Upon selection of a defined countermeasure, a similar data-driven approach can be used to select or create a parameter set with which to populate the defined countermeasure.

In embodiments, a defined countermeasure that has been selected for application against a novel, ambiguous, or unresponsive imminent radar threat is populated with an initial parameter set, after which the applied parameters are varied and optimized according to observed changes in behavior of the one or more waveforms that are emitted by the novel threat, for example as recorded by a human observer or by using the method of co-pending U.S. application Ser. No. 16/953,579, also by the present Applicant, which is incorporated herein in its entirety by reference for all purposes.

A defined countermeasure that has been selected as described above can be populated by a default parameter set that is associated with the defined countermeasure, or the parameter set can be determined as a “closest match” parameter set according to any of the approaches described above, including a data-driven approach using a trained artificial intelligence. In particular, a data-drive approach such as an artificial intelligence is used in some embodiments to create a parameter set for a defined countermeasure that is predicted to be effective against a novel threat

In some embodiments, a known threat database is not included as part of the disclosed threat mitigation system. Instead, all detected waveforms are considered to be novel, and each selection of a known or defined countermeasure from the countermeasure library is made based on known relationships between RF waveform features and available countermeasures and/or by using a pre-trained artificial intelligence.

In other embodiments, the disclosed method is used in combination with existing methods, whereby a detected waveform is first compared to a threat database to determine if it is a known waveform. If the detected waveform is found in the threat database, then an associated countermeasure is implemented according to known strategies. If the applied countermeasure is determined to be effective, then it may not be deemed necessary to implement any of the novel methods of the present disclosure. On the other hand, if the detected waveform is novel, ambiguous, or unresponsive to a previously verified countermeasure, then the disclosed method can be used to make an appropriate selection of a defined or known countermeasure from a countermeasure library so that the countermeasure can be applied against the imminent radar threat.

A first general aspect of the present disclosure is a method of protecting an asset from an imminent radar threat that is emitting a hostile radio frequency (RF) waveform and poses an imminent threat to the asset, said imminent radar threat being unknown, ambiguous, or unresponsive. The method includes detecting the hostile RF waveform, determining that the imminent radar threat is unknown, ambiguous, or unresponsive, performing an analysis of the detected hostile RF waveform, according to the analysis, selecting a defined countermeasure from a library of countermeasures, creating a populated countermeasure by populating the selected, defined countermeasure with a parameter set, and implementing the populated countermeasure, thereby disrupting the imminent radar threat and protecting the asset.

In embodiments, performing the analysis of the hostile RF waveform includes determining a feature of the hostile RF waveform, and identifying a known RF waveform included in a database of known radar threats having a feature that is identical or similar to the identified feature of the hostile RF waveform. In some of these embodiments, the method further comprises determining a feature category to which the identified feature of the hostile RF waveform belongs, and wherein the selected defined countermeasure has been previously verified as effective against a known radar threat that emits a known RF waveform having a feature in the determined feature category. In any of these embodiments, the selected defined countermeasure cam be linked to the determined feature, in that the selected defined countermeasure has previously been verified as effective against a plurality of known radar threats that emit known RF waveforms having features identical or similar to the identified feature of the hostile RF waveform.

In any of the above embodiments, performing the analysis of the hostile RF waveform can includes determining a plurality of features of the hostile RF waveform, and identifying a known RF waveform included in a database of known radar threats having features that are identical or similar to the plurality of features of the hostile RF waveform.

In any of the above embodiments, populating the selected defined countermeasure with a parameter set can include populating the selected, defined countermeasure with a parameter set that is associated with the selected defined countermeasure in the library of countermeasures.

In any of the above embodiments, performing the analysis of the detected hostile RF waveform can include providing a plurality of known threat waveforms and associated countermeasures as training data to an artificial intelligence, thereby training the artificial intelligence, and causing the trained artificial intelligence to perform the analysis of the hostile RF waveform. In some of these embodiments, populating the selected defined countermeasure with the parameter set includes causing the trained artificial intelligence to select or generate the parameter set according to the analysis of the hostile RF waveform.

In any of the above embodiments, detecting the hostile RF waveform can include detecting and discriminating a plurality of hostile RF waveforms emitted by the imminent radar threat, and performing the analysis of the detected hostile RF waveform can include performing an analysis of the detected plurality of hostile RF waveforms. In some of these embodiments, performing the analysis of the detected plurality of hostile RF waveforms includes analyzing correlations between behavior patterns of the detected plurality of hostile RF waveforms.

In any of the above embodiments, selecting the defined countermeasure from the library of countermeasures can include selecting a plurality of defined countermeasures from at least one library of countermeasures, creating a plurality of populated countermeasures by populating each of the selected defined countermeasures with a corresponding parameter set, and implementing the plurality of populated countermeasures. In some of these embodiments, the plurality of populated countermeasures are implemented simultaneously.

In any of the above embodiments, determining that the imminent radar threat is unknown, ambiguous, or unresponsive can includes comparing the hostile RF waveform with known RF waveforms contained in a threat database, if the hostile RF waveform can be unambiguously matched with one of the known RF waveforms, selecting and implementing an associated known countermeasure from the countermeasure library, and if the associated known countermeasure is effective against the imminent radar threat, designating the imminent radar threat as a known radar threat while if the associated known countermeasure is not effective against the imminent radar threat, designating the imminent radar threat as an unresponsive radar threat, and if the hostile RF waveform cannot be unambiguously matched with one of the known RF waveforms, designating the imminent radar threat as an unknown or ambiguous radar threat.

A second general aspect of the present disclosure is an apparatus for protecting an asset from an imminent radar threat that is emitting a hostile radio frequency (RF) waveform and poses an imminent threat to the asset, said hostile RF waveform being unknown, ambiguous, or unresponsive. The apparatus includes an antenna configured to receive the hostile RF waveform, a receiver configured to amplify and digitize the hostile RF waveform, a signal analyzer configured to isolate the hostile RF waveform, a countermeasure library containing known countermeasures that are pre-verified as effective in disrupting associated known radar threats, and a Cognitive Electronic Warfare System (CEW) configured to analyze the hostile RF waveform, according to said analysis select a defined countermeasure from the countermeasure library, and create a populated countermeasure for application against the imminent radar threat by populating the selected defined countermeasure with a parameter set.

In embodiments, the signal analyzer is further configured to use data-driven machine learning to separate and isolate the hostile RF waveform from other signals received by the antenna.

In any of the above embodiments, the signal analyzer can be further configured to use data-driven machine learning to select or generate the parameter set.

And any of the above embodiments can further include a threat database, and a waveform identifier configured to compare the hostile RF waveform with known RF waveforms stored in the threat database, and to determine if the radar threat is known, novel, or ambiguous.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow diagram that illustrates a method embodiment of the present disclosure;

FIG. 2 is a flow diagram that illustrates implementation of an artificial intelligence in selecting a countermeasure from a countermeasure library in a method embodiment of the present disclosure; and

FIG. 3 is a block diagram of an apparatus embodiment of the present disclosure.

### DETAILED DESCRIPTION

The present disclosure is a system and method for selecting and implementing a countermeasure that is effective against a radar threat when the radar threat is either an unidentified radar threat or is identified as a known radar threat but is not being sufficiently disrupted by a previously validated countermeasure.

According to the present disclosure, “detected” features (i.e. directly measured features) and in embodiments also “derived” features (i.e. additional features that are determined from combinations of detected features, including their temporal dynamics) of an RF waveform that is emitted by an unidentified, ambiguous, or unresponsive radar threat are used as a basis for selecting a defined countermeasure from a countermeasure library, even though the selected countermeasure has not been previously validated against the radar threat.

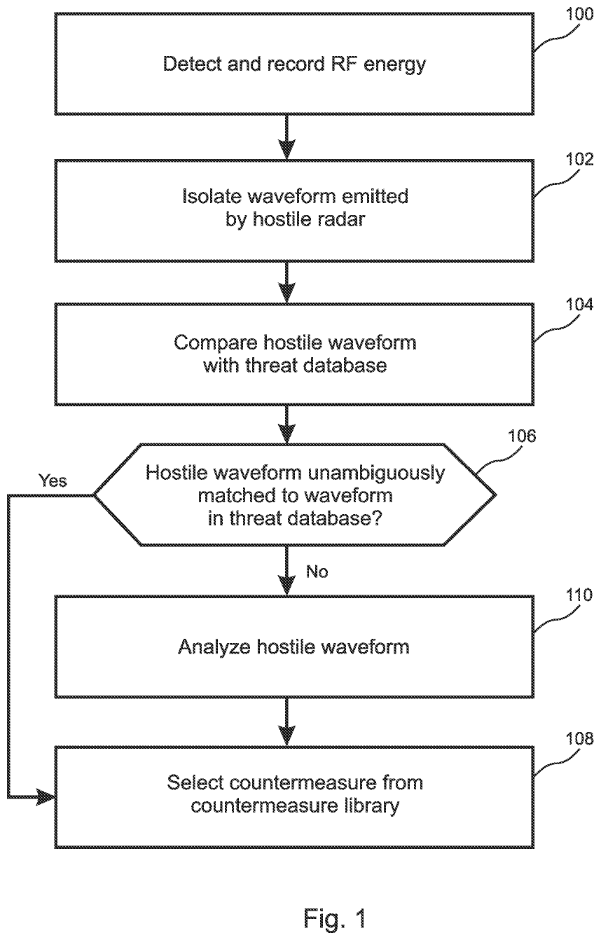

With reference to FIG. 1, embodiments detect and record RF energy 100 received over a broad range of frequencies, and then analyze the received RF energy 102 to identify and isolate hostile radars and the RF waveforms that they are emitting. These “detected” hostile RF waveforms are then processed as candidates for the application of countermeasures.

In some embodiments, each detected hostile RF waveform is compared 104 to a threat database to determine if it is a known hostile waveform. If the detected hostile RF waveform is unambiguously matched to an RF waveform in the threat database 106, then an associated known countermeasure is selected 108 from a countermeasure library. On the other hand, if the detected hostile RF waveform is a novel or ambiguous waveform, i.e. a hostile waveform that is not unambiguously matched to an RF waveform included in an available threat database, then the novel or ambiguous waveform is analyzed 110, and a defined countermeasure is selected 108 and parameterized from the countermeasure library on the basis of the analysis of the novel or ambiguous waveform. If the detected hostile RF waveform is known and a corresponding known countermeasure is applied but is not effective, then the hostile RF waveform and associated radar threat are designated to be unresponsive, and the detected hostile RF waveform is treated as if it were a novel or ambiguous RF waveform.

In other embodiments, comparison with a threat library is not included as part of the disclosed method. Instead, all detected hostile RF waveforms are considered to be novel RF waveforms, and each selection of a defined countermeasure from the countermeasure library is made according to an analysis of the detected hostile RF waveform.

In embodiments, the analysis of the novel RF waveform includes characterizing the novel RF waveform according to a plurality of feature categories. For example, with reference to Table 1 below, if the feature categories include amplitude modulation type, frequency modulation type, and geographic dispersion pattern, then a first Rf waveform might be characterized according to these categories as having a fixed amplitude, a fixed frequency, and a swept, 360 degree geographic dispersion pattern, while a second RF waveform might be characterized as having a pulsed amplitude modulation, a hopped frequency modulation, and a geographic dispersion pattern that attempts to remain fixed on a selected target.

TABLE 1
Example of waveform features and categories

| Feature | Amplitude | Frequency | Geographic |
|---|---|---|---|
| Category: | Modulation | Modulation | Dispersion |
| Waveform #1 | Fixed Amplitude | Fixed frequency | Swept 360 deg. |
| Waveform #2 | Pulsed Amplitude | Frequency Hopped | Fixed on target |
| Waveform #3 | Sawtooth | Chirped | Limited sweep |

Sub-categories can also be included as part of the feature categorization, such as a pulse repetition rate and duty cycle applicable to pulsed amplitude modulation, and a hopping rate and number of frequencies included in a hopped frequency modulation.

This approach of characterizing novel, ambiguous, and unresponsive RF waveforms according to features that belong to categories and sub-categories can enable rapid identification of a “closest match” known threat waveform that “matches” the novel, ambiguous, or unresponsive RF waveform in the largest number of feature categories and sub-categories. Table 2 below present a simple example where known threat waveform #2 is a closest match to a novel RF waveform.

TABLE 2
Example of comparing a novel RF waveform to known RF waveforms

| Feature | Amplitude | Frequency | Geographic |
|---|---|---|---|
| Category: | Modulation | Modulation | Dispersion |
| Novel | Pulsed Amplitude | Frequency hopped | Swept 360 deg. |
| Waveform | | | |
| Waveform #1 | Fixed Amplitude | Fixed frequency | Swept 360 deg. |
| Waveform #2 | Pulsed Amplitude | Frequency hopped | Fixed on target |
| Waveform #3 | Sawtooth | Chirped | Limited sweep |

In the example of Table 2, the countermeasure that is known to be most effective against known threat waveform #2 would likely be selected and applied to the detected novel RF waveform, because it matches the novel waveform in two of the three categories.

The example of Tables 1 and 2 is, of course, relatively simple and intended to illustrate a basic concept of embodiments of the present disclosure. In other embodiments, detected and derived features of a novel, ambiguous, or unresponsive RF waveform are compared with a set of general waveform features instead of, or in addition to, a comparison with features of known waveforms. In particular, embodiments compare detected and derived features of a novel, ambiguous, or unresponsive RF waveform with general classes of waveform features that are often mutually associated, as can be determined for example by applying machine learning to the features of known hostile RF waveforms.

Accordingly, a data-driven approach can be applied in advance to recognize associations between hostile RF waveform features that may not be apparent from a simple cataloging of known hostile RF waveform feature combinations, thereby providing additional flexibility and an expanded ability to select and optimize countermeasures for application against novel, ambiguous, and unresponsive RF waveforms. In principle, all possible unique combinations of individual features can be considered. However, embodiments employ a preapplication of machine learning and analysis to identify which combinations of features are valid, serve the purpose of a radar, and conform to the laws of physics. In general, either or both of these approaches can be applied, i.e. the approach of directly comparing and matching detected and derived features with known hostile database features, and the approach of comparing and matching detected and derived features with abstracted associations between hostile waveform features, as determined for example using machine learning.

Embodiments further attempt to determine relationships or “links” between waveform features and defined countermeasures, so that the links can be used to further optimize the selection of a defined countermeasure to be applied against a threat that is emitting RF energy having a novel waveform. These links can take the form of assessing the similarity or dis-similarity between a novel waveform and either a specific known hostile waveform or a more general class of hostile waveform, as identified for example by applying machine learning to a database of known hostile waveforms.

For example, with reference to Table 3 below, if defined countermeasure #1, when populated with an associated parameter set, is effective against known threat waveforms 1-3, all of which include frequency hopping, but include various amplitude modulation patterns, while defined countermeasure #2, when populated with an associated parameter set, is effective against threat waveforms 2, 4, and 5, which differ in their frequency modulation patterns, but all of which include a pulsed amplitude, then, in embodiments, defined countermeasure #1 will be deemed to be linked to frequency hopping but not to pulsed amplitudes, while defined countermeasure #2 will not be linked to frequency hopping, but will be linked to pulsed amplitudes. Of course, in embodiments the linkage of waveform features to defined countermeasures does not necessarily require that a linked feature be shared by all of the known waveforms against which the defined countermeasure is known to be effective.

TABLE 3
Example of linking features to countermeasures

| | | | |
|---|---|---|---|
| Feature | Amplitude | Frequency | Geographic |
| Category: | Modulation | Modulation | Dispersion |

Defined Countermeasure #1, effective against:

| | | | |
|---|---|---|---|
| Waveform #1 | Fixed Amplitude | Frequency Hopped | Swept 360 deg. |
| Waveform #2 | Pulsed Amplitude | Frequency Hopped | Fixed on target |
| Waveform #3 | Sawtooth | Frequency Hopped | Limited sweep |

Defined Countermeasure #2, effective against:

| | | | |
|---|---|---|---|
| Waveform #2 | Pulsed Amplitude | Frequency Hopped | Fixed on target |
| Waveform #4 | Pulsed Amplitude | fixed | Fixed on target |
| Waveform #5 | Pulsed Amplitude | chirped | Limited sweep |
| Novel | Fixed amplitude | Frequency Hopped | Fixed on target |
| Waveform | | | |

With continuing reference to the very simple example of Table 3, if a detected novel waveform is characterized by a fixed amplitude, frequency hopping, and a geographic dispersion that remains fixed on a target, then according to the example presented in Table 3 the novel waveform would be an equally close match to both known threat waveform #1 and known threat waveform #2, such that defined countermeasure #1 and defined countermeasure #2 would both be candidates for selection from the countermeasure library. However, as discussed above, defined countermeasure #1 is linked to frequency hopping, while defined countermeasure #2 is linked to a pulsed amplitude. Therefore, because the novel waveform includes frequency hopping but does not include a pulsed amplitude, defined countermeasure #1 would be selected from the countermeasure library and implemented against the novel RF waveform.

It should be noted that the examples discussed above with reference to Tables 1-3 are highly simplified, and are intended only to illustrate principles that apply to embodiments of the present disclosure, and do not necessarily present realistic examples.

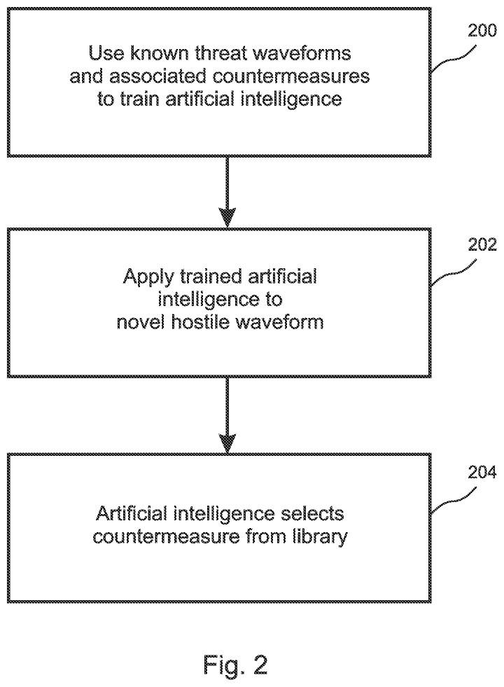

As noted above, in various embodiments machine learning is implemented to select an optimal countermeasure to be used against a hostile radar that emits RF energy having a novel waveform. In some of these embodiments, with reference to FIG. 2, a plurality of known threat waveforms and their associated countermeasures are provided as training data to an artificial intelligence 200, after which the trained artificial intelligence is implemented to analyze each novel waveform 202, and to select an optimal countermeasure 204 from a countermeasure library. In various embodiments, the training data that is provided to the artificial intelligence can be, or can include, hypothesized waveforms that are derived from general features of known threat waveforms by machine learning, as is described above, by analyzing the feature combinations that are most likely to make-up waveform types, rather than being limited to only known waveforms.

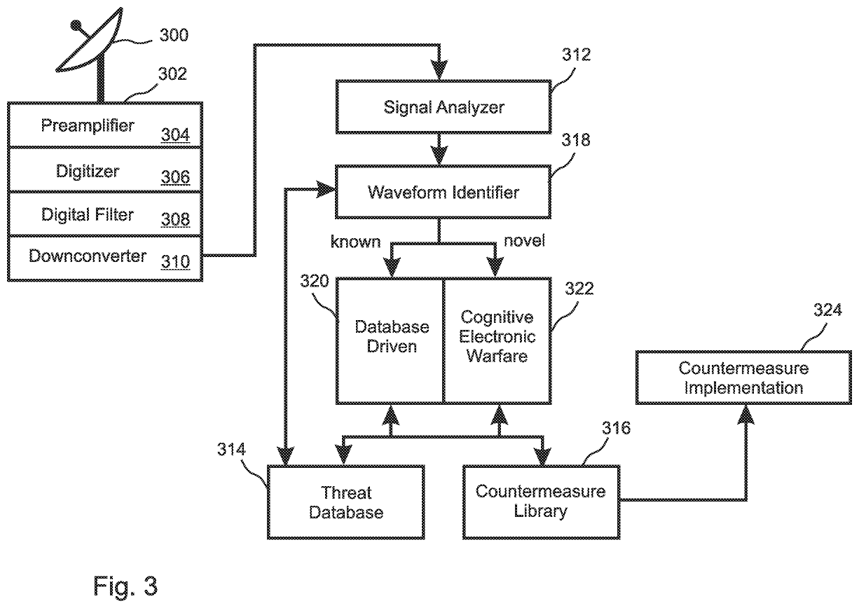

With reference to FIG. 3, in embodiments the disclosed system includes an antenna 300 that captures wireless RF signals and directs them to receiver electronics 302 that may include a preamplifier 304 and digitizer 306, as well as a digital filter 308 and a digital downconverter 310 configured to eliminate the carrier frequency of the detected RF and to convert the detected RF to baseband. Embodiments of the present system further include a Signal Analyzer 312 that uses data-driven machine learning to separate (de-interleave) and isolate from each other the hostile radar-emitted waveforms that are present in the RF environment, and, in embodiments, associates each of the hostile RF waveforms with the hostile radar from which it is being emitted. In embodiments, data-driven machine learning, such as self-guided clustering, is used to de-interleave the RF waveforms, determine the features that characterize each of the RF waveforms, and in some embodiments to classify each of the hostile RF waveforms as to the inferred mode and intent of the associated radar according to its features and behavior.

The system further includes a countermeasure library 316, and in embodiments also a threat database 314 in which characterizing features of known threat waveforms are stored together with links between the known threat waveforms and associated known countermeasures contained in the countermeasure library 316 that were previously verified to be effective against the known threat waveforms. In embodiments, the threat database 314 also includes parameters associated with each of the threat waveforms that are to be used to populate the associated defined countermeasure.

In embodiments, a waveform identifier 318 compares detected waveforms that are isolated by the Signal Analyzer 312 with the known hostile waveforms that are contained in the threat database 314, and identifies each of the detected waveforms as either a known, ambiguous, or novel hostile waveform that is a candidate for application of a countermeasure, or as non-hostile waveform that is not a candidate for application of a countermeasure.

If a detected waveform is uniquely matched with a hostile waveform found in the threat database 314 and is therefore a known hostile waveform, then in embodiments a database driven warfare system 320 selects a defined or known countermeasure from the countermeasure library 316 according to the links between the known threats and countermeasures. Otherwise, if the detected waveform is a novel or ambiguous (hostile) RF waveform, then a Cognitive Electronic Warfare (CEW) system 322 analyses the novel or ambiguous RF waveform and selects an optimal defined countermeasure from the countermeasure library 316 according to the novel methods disclosed herein.

In either case, the selected defined countermeasure is then forwarded to appropriate countermeasure implementation systems 324 for population with appropriate parameters and implementation. If a pre-verified countermeasure applied to a known threat is found to be ineffective, then the known threat is re-classified as an unresponsive threat, and is treated as if it were a novel threat.

The foregoing description of the embodiments of the disclosure has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the disclosure to the precise form disclosed. Many modifications and variations are possible in light of this disclosure.

Although the present application is shown in a limited number of forms, the scope of the disclosure is not limited to just these forms, but is amenable to various changes and modifications without departing from the spirit thereof. The disclosure presented herein does not explicitly disclose all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

We claim:

1. A method of protecting an asset from an imminent radar threat that is emitting a hostile radio frequency (RF) waveform and poses an imminent threat to the asset, said imminent radar threat being unknown, ambiguous, or unresponsive, the method comprising:
detecting the hostile RF waveform;
determining that the imminent radar threat is unknown, ambiguous, or unresponsive;
performing an analysis of the detected hostile RF waveform;
according to the analysis, selecting a defined countermeasure from a library of countermeasures;
creating a populated countermeasure by populating the selected, defined countermeasure with a parameter set; and
implementing the populated countermeasure, thereby disrupting the imminent radar threat and protecting the asset.

2. The method of claim 1, wherein performing the analysis of the hostile RF waveform includes:
determining a feature of the hostile RF waveform; and
identifying a known RF waveform included in a database of known radar threats having a feature that is identical or similar to the identified feature of the hostile RF waveform.

3. The method of claim 2, wherein the method further comprises determining a feature category to which the identified feature of the hostile RF waveform belongs, and wherein the selected defined countermeasure has been previously verified as effective against a known radar threat that emits a known RF waveform having a feature in the determined feature category.

4. The method of claim 2, wherein the selected defined countermeasure is linked to the determined feature, in that the selected defined countermeasure has previously been verified as effective against a plurality of known radar threats that emit known RF waveforms having features identical or similar to the identified feature of the hostile RF waveform.

5. The method of claim 1, wherein performing the analysis of the hostile RF waveform includes:
determining a plurality of features of the hostile RF waveform; and
identifying a known RF waveform included in a database of known radar threats having features that are identical or similar to the plurality of features of the hostile RF waveform.

6. The method of claim 1, wherein populating the selected defined countermeasure with a parameter set includes populating the selected, defined countermeasure with a parameter set that is associated with the selected defined countermeasure in the library of countermeasures.

7. The method of claim 1, wherein performing the analysis of the detected hostile RF waveform includes:
providing a plurality of known threat waveforms and associated countermeasures as training data to an artificial intelligence, thereby training the artificial intelligence; and
causing the trained artificial intelligence to perform the analysis of the hostile RF waveform.

8. The method of claim 7, wherein populating the selected defined countermeasure with the parameter set includes causing the trained artificial intelligence to select or generate the parameter set according to the analysis of the hostile RF waveform.

9. The method of claim 1, wherein:
detecting the hostile RF waveform includes detecting and discriminating a plurality of hostile RF waveforms emitted by the imminent radar threat; and
performing the analysis of the detected hostile RF waveform includes performing an analysis of the detected plurality of hostile RF waveforms.

10. The method of claim 9, wherein performing the analysis of the detected plurality of hostile RF waveforms includes analyzing correlations between behavior patterns of the detected plurality of hostile RF waveforms.

11. The method of claim 1, wherein selecting the defined countermeasure from the library of countermeasures includes:
selecting a plurality of defined countermeasures from at least one library of countermeasures;
creating a plurality of populated countermeasures by populating each of the selected defined countermeasures with a corresponding parameter set; and
implementing the plurality of populated countermeasures.

12. The method of claim 11, wherein the plurality of populated countermeasures are implemented simultaneously.

13. The method of claim 1, wherein determining that the imminent radar threat is unknown, ambiguous, or unresponsive includes:
comparing the hostile RF waveform with known RF waveforms contained in a threat database;
if the hostile RF waveform can be unambiguously matched with one of the known RF waveforms, selecting and implementing an associated known countermeasure from the countermeasure library, and:
if the associated known countermeasure is effective against the imminent radar threat, designating the imminent radar threat as a known radar threat;
if the associated known countermeasure is not effective against the imminent radar threat, designating the imminent radar threat as an unresponsive radar threat; and
if the hostile RF waveform cannot be unambiguously matched with one of the known RF waveforms, designating the imminent radar threat as an unknown or ambiguous radar threat.

14. An apparatus for protecting an asset from an imminent radar threat that is emitting a hostile radio frequency (RF) waveform and poses an imminent threat to the asset, said hostile RF waveform being unknown, ambiguous, or unresponsive, the apparatus comprising:
an antenna configured to receive the hostile RF waveform;
a receiver configured to amplify and digitize the hostile RF waveform;
a signal analyzer configured to isolate the hostile RF waveform;
a countermeasure library containing known countermeasures that are pre-verified as effective in disrupting associated known radar threats; and
a Cognitive Electronic Warfare System (CEW) configured to:
analyze the hostile RF waveform;
according to said analysis, select a defined countermeasure from the countermeasure library; and
create a populated countermeasure for application against the imminent radar threat by populating the selected defined countermeasure with a parameter set.

15. The apparatus of claim 14, wherein the signal analyzer is further configured to use data-driven machine learning to separate and isolate the hostile RF waveform from other signals received by the antenna.

16. The apparatus of claim 14, wherein the signal analyzer is further configured to use data-driven machine learning to select or generate the parameter set.

17. The apparatus of claim 14, further comprising:
a threat database; and
a waveform identifier configured to compare the hostile RF waveform with known RF waveforms stored in the threat database, and to determine if the radar threat is known, novel, or ambiguous.
